(19) United States
(12) Patent Application Publication
(10) Pub. No.: US 2008/0053290 A1
(43) Pub. Date: Mar. 6, 2008

(54) CLIPPING DEVICE FOR A DRUM COUNTERHOOP

(76) Inventors: Chang-Hui Chen, Taichung Hsien (TW); Tsun-Wu Liao, Taichung City (TW)

Correspondence Address: LEONG C LEI, PMB # 1008, 1867 YGNACIO VALLEY ROAD, WALNUT CREEK, CA, 94598, US

(21) Appl. No.: 11/468,781

(22) Filed: Aug. 31, 2006

(51) Int. Cl. G10D 13/02

(52) U.S. Cl. 84/411 R

(57) ABSTRACT

A clipping device for a drum counterhoop is disclosed. The clipping device is substantially a C-shaped body with an inner edge bottom pivotally mounted to an actuating board frame, the middle section of the board frame is a screw rod protruded out to the C-shaped body to control simultaneously an actuating at the external end of the actuating board frame such that the actuating plate is conveniently pivotally mounted to the counterhoop of the drum, the external edge of the C-shaped body is disposed with a securing seat and the upper section of the seat body is pivotally locked with a fastening cap, in combination with the urging of the locking rod of a locking device, a frame insertion module for mounting musical components is inserted into the securing seat and is locked.

### BACKGROUND OF THE INVENTION

(a) Technical Field of the Invention

The present invention relates to drum, and in particular, to a clipping device for a drum counterhoop.

(b) Description of the Prior Art

In the course of performing musical instruments, a plurality of frames or clipping devices are used. For instance, as shown in FIG. 6, the drum 30 is mounted with a combination frame 31 for holding different types of other related musical instruments to allow a drummer to performance using all these musical components. Conventionally, these musical components are separate units standing on the floor using a leg frame 33 mounted thereto. A flat floor is needed in order to allow these components to be stood securely. Therefore, not only that a larger space is required, but also cause inconvenience to the drummer. When the leg frame 33 is stretched to stand on the floor, available space to the drummer is limited. Accordingly, it is an object of the present invention to provide a clipping device which simplifies the mounting of other musical components and also provide a larger performing space to the drummer.

### SUMMARY OF THE INVENTION

The primary purpose of the present invention is to provide a clipping device for a drum counterhoop which is mounted to the counterhoop of the drum for further connection of a clipping frame, facilitating the mounting of other musical components such that the volume of these musical components is greatly reduced and facilitating the mounting of the musical components.

Still another object of the present invention is to provide a clipping device for a drum counterhoop having a drum frame shaft characterized in that the clipping device is substantially a C-shaped body with an inner edge bottom pivotally mounted to an actuating board frame, the middle section of the board frame is a screw rod protruded out to the C-shaped body to control simultaneously an actuating at the external end of the actuating board frame such that the actuating plate is conveniently pivotally mounted to the counterhoop of the drum, the external edge of the C-shaped body is disposed with a securing seat and the upper section of the seat body is pivotally locked with a fastening cap, in combination with the urging of the locking rod of a locking device, a frame insertion module for mounting musical components is inserted into the securing seat and is locked.

The foregoing object and summary provides only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a clipping device for a drum counterhoop of the present invention.

FIG. 2 is a perspective view of the clipping device for a drum counterhoop of the present invention.

FIG. 3 is a schematic view showing the locking or mounting of the clipping device onto the drum counterhoop of the present invention.

FIG. 4 is a sectional view showing the application of the clipping device in accordance with the present invention.

FIG. 5 is a perspective view showing the application of the clipping device onto the counterhoop of a drum in accordance with the present invention.

FIG. 6 is a conventional drum set.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

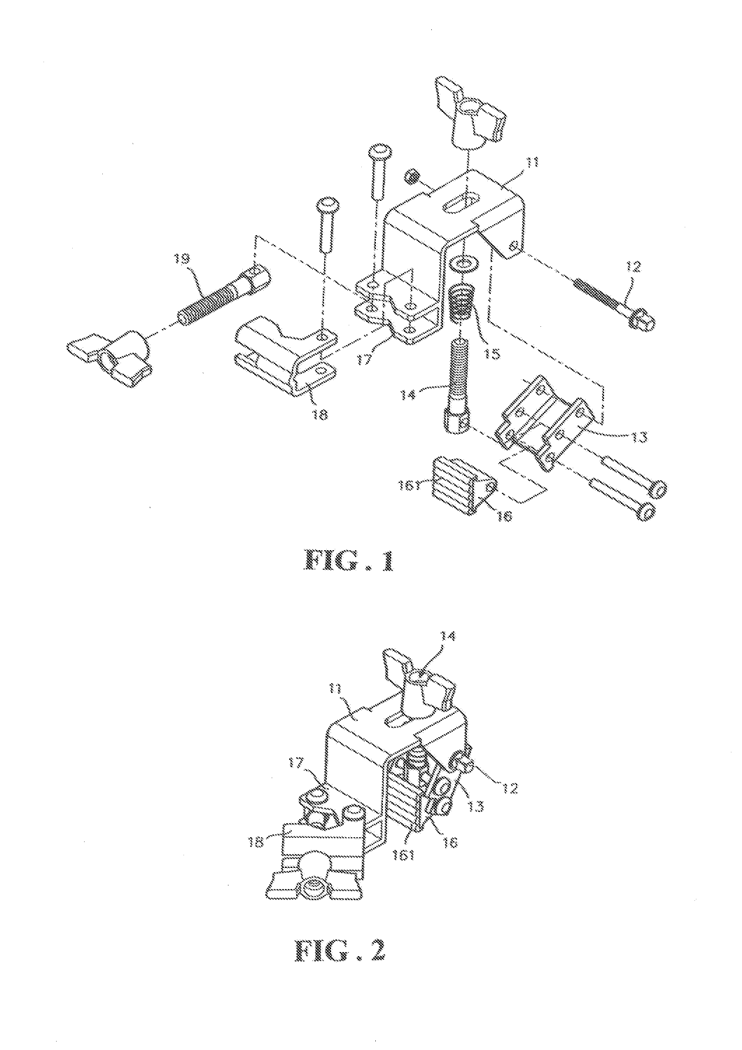

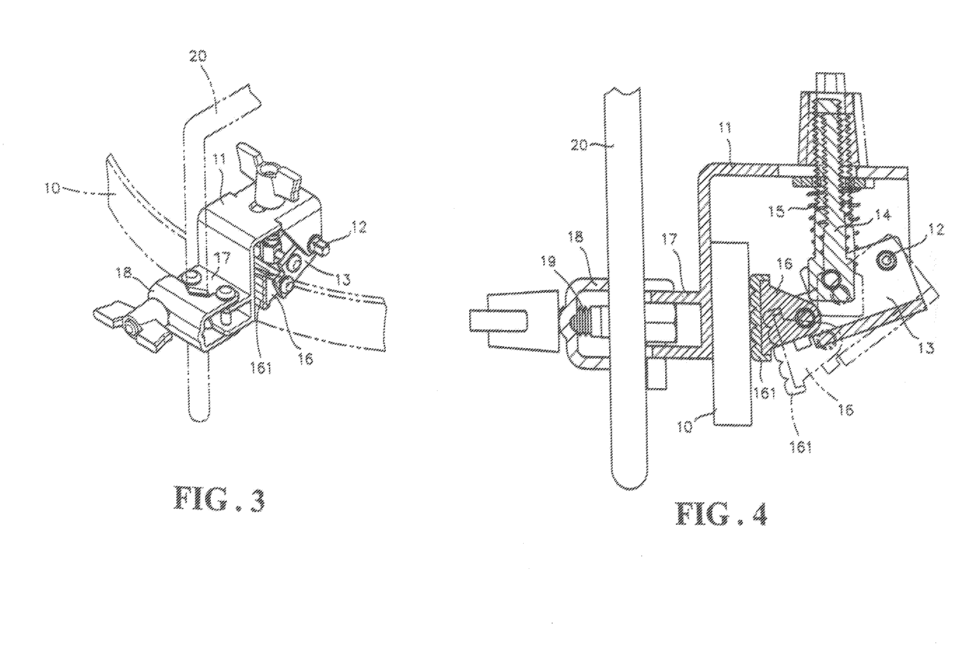

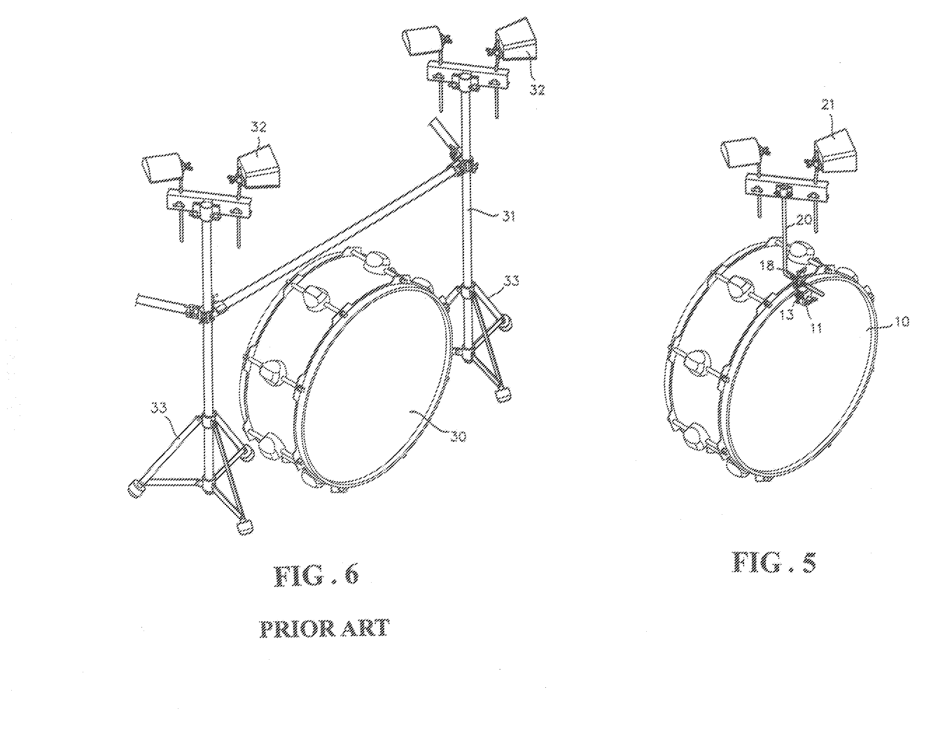

Referring to FIGS. 1 to 5, there is shown a clipping device to be mounted onto the counterhoop of a drum. The drum 10 is a mounting framework and the counterhoop of the drum 10 is in combination with a C-shaped clipping body 11. The bottom section of the C-shaped body is a pivotal hole for pivoting of a pivot shaft 12 to an actuating board 13. The middle section of the actuating board is pivoted to a screw rod 14 of a locking device for adjustment, and the screw rod 14 is mounted with an elastic element 15 and is protruded out to the clipping body 11. The end of the external side of the actuating board 13 is pivotally mounted with an actuating plate 16, and the top face of the V-shaped actuating plate 16 is wider and has a rough or coarse surface, and a soft pad 161 can be adhered, facilitating the movement of the pivot such that the wider face can secure the clipping device to the counterhoop of the drum. This mounting of the clipping device will not damage the counterhoop. The adjustment of the locking of the screw rod 14 causes the board 13 to move and this will simultaneously activate the actuating plate 16 to swing with an angle, and therefore the clipping device is secured to the counterhoop. The C-shaped top edge of the body 11 is a securing seat 17 having a V-shaped slot, and the top section of the seat body is a binding cap 18 in combination with the locking rod 19 to secure tight mounting and to facilitate musical devices to be mounted onto the rod 20 for disposing at the securing seat 17, and to allow mounting of various musical devices 21.

In accordance with the present invention, the drum 10 is placed horizontally and the actuating board 13 is locked by means of the screw rod 14 on the body 11, such that the actuating plate 16 is mounted at the counterhoop of the drum. The soft pad prevents the damaging of the counterhoop. The large counterhoop of the drum allows the clipping device 10 to be secured at any appropriate position, and the easy mounting of the C-shaped rod 20 provides a convenience for the holding of small musical devices.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A clipping device for a drum counterhoop having a drum frame shaft characterized in that the clipping device is substantially a C-shaped body with an inner edge bottom pivotally mounted to an actuating board frame, the middle section of the board frame is a screw rod protruded out to the C-shaped body to control simultaneously an actuating at the external end of the actuating board frame such that the actuating plate is conveniently pivotally mounted to the counterhoop of the drum, the external edge of the C-shaped body is disposed with a securing seat and the upper section of the seat body is pivotally locked with a fastening cap, in combination with the urging of the locking rod of a locking device, a frame insertion module for mounting musical components is inserted into the securing seat and is locked.

2. The clipping device of claim 1, wherein the locking rod of a locking device for adjustment is mounted with an elastic element.

3. The clipping device of claim 1, wherein the securing seat is provided with a V-shaped slot.

4. The clipping device of claim 3, wherein the actuating plate is V-shaped and has a wider top face which is a coarse surface.

5. The clipping device of claim 1 or 4, wherein the top face of the actuating plate is an elastic soft pad.
